(19) United States
(12) Patent Application Publication
(10) Pub. No.: US 2015/0199878 A1
(43) Pub. Date: Jul. 16, 2015

(54) SYSTEM AND METHOD FOR CONDUCTING A TOURNAMENT IN A GAMING NETWORK

(71) Applicant: PALTRONICS AUSTRALASIA PTY LIMITED, Taren Point (AU)

(72) Inventors: Dean WRIGHT, Sydney (AU); Stephen COWAN, Sydney (AU); Ali JOMAA, Sydney (AU)

(21) Appl. No.: 14/592,626

(22) Filed: Jan. 8, 2015

(30) Foreign Application Priority Data
Jan. 13, 2014 (AU) 2014900096

(51) Int. Cl. G07F 17/32

(52) U.S. Cl. CPC G07F 17/3276

(57) ABSTRACT

A method for conducting tournament game play in a gaming network comprising a plurality of inter-linked gaming machines. The method comprise determining whether a tournament trigger condition has been met during a non-tournament play period during which players of the gaming machines are able to play respective primary games thereon. Responsive to determining that the tournament trigger condition has been met, a tournament entry period is commenced during which players of the gaming machines that meet a tournament participation criterion are offered the opportunity to enter a tournament in which a major tournament prize is awardable. Upon the tournament entry period closing, a tournament play period is commenced during which players of each of the inter-linked gaming machines are able to continue play of the respective primary games. Responsive to determining that an award condition has been met during the tournament play period, the major tournament prize is awarded to the player of a gaming machine that has entered into the tournament based on an evaluation of data related to play of the primary games on the respective gaming machines during the tournament play period.

### FIELD OF THE INVENTION

The present invention relates to a system, apparatus and method for conducting a tournament style game in a gaming network. The invention has been developed primarily for use with a plurality of inter-linked gaming machines in a gaming establishment and will be described with reference to this application. However, the invention is not limited to that particular field of use and is also suitable for use with online gaming, gaming machines that are distributed over a plurality of gaming establishments, lotto, pools, lotteries, art unions, bingo, raffles and other games involving one or more wagers being placed on an outcome having a finite probability of occurring.

### BACKGROUND OF THE INVENTION

The discussion of prior art within this specification is to assist the addressee to understand the invention and is not an admission to the extent of the common general knowledge in the field of the invention and is included without prejudice.

Many modern-day gaming venues implement networked gaming systems whereby multiple gaming devices are able to communicate with a central controller, for example, to allow the devices to participate in a linked game event, provide remote monitoring/control of the game devices, etc.

One common form of linked game event is a tournament event, whereby players of linked gaming machines are able to compete against other players to win a tournament prize. Typically a trigger (e.g. a symbol driven trigger) determined on one of the gaming machines will cause the gaming machines to enter a tournament mode whereby primary game play is suspended in favour of the dedicated tournament game. While such linked game events do increase player interest, they can be costly to implement due to each of the gaming machines needing to be specifically configured to run the dedicated tournament game. Furthermore, while the dedicated tournament game is being played the gaming venue loses out on revenue it would have otherwise been receiving through play of the standard games on the respective gaming machines.

### SUMMARY OF THE INVENTION

A first aspect of the invention provides a method for conducting tournament game play in a gaming network comprising a plurality of inter-linked gaming machines, the method comprising:
determining whether a tournament trigger condition has been met during a non-tournament play period during which players of the gaming machines are able to play respective primary games thereon;
responsive to determining that the tournament trigger condition has been met, commencing a tournament entry period during which players of the gaming machines that meet a tournament participation criterion are offered the opportunity to enter a tournament in which a major tournament prize is awardable;
upon the tournament entry period closing, commencing a tournament play period during which players of each of the inter-linked gaming machines are able to continue play of the respective primary games; and
responsive to determining that an award condition has been met during the tournament play period, awarding the major tournament prize to the player of a gaming machine that has entered into the tournament based on an evaluation of data related to play of the primary games on the respective gaming machines during the tournament play period.

In an embodiment the data related to play of the primary games comprises data indicative of funds won through play of the primary games and wherein the major tournament prize is awarded to the gaming machine which has accumulated the greatest value of funds won during the tournament play period.

In an embodiment the method further comprises evaluating a win meter for each of the gaming machines which records a number of credits won through play of the respective primary game to determine which of the gaming machines has accumulated the greatest value of won funds.

In an embodiment the method further comprises displaying a ranking during the tournament play period for each of the gaming machines that have entered into the tournament based on the current value of won funds as determined from the respective win meters.

In an embodiment the method further comprises awarding a token to players of inter-linked gaming machines that meet the tournament participation criterion, the token being used to enter into the current tournament or stored against a player profile for use in entering into a future tournament where the player has not met the tournament participation criterion.

In an embodiment the method further comprises awarding a minor prize to all players of inter-linked gaming machines that meet the tournament participation criterion.

In an embodiment the method further comprises requiring players to forgo the minor prize in order to enter into the tournament.

In an embodiment each of the inter-linked gaming machines contribute a portion of turnover from play of the respective primary games to a prize pool from which the tournament prize(s) are funded.

In an embodiment the major tournament prize is a progressive jackpot such that a value of the jackpot prize is proportionate to a value of the prize pool.

In an embodiment the method further comprises allowing the jackpot prize value to increase during the tournament entry period through play of standard games on any one of the inter-linked gaming machines.

In an embodiment the method further comprises displaying a current jackpot prize value to players during the enrolment period.

In an embodiment the tournament trigger condition takes into consideration a current value of the prize pool and/or jackpot prize.

In an embodiment the determination as to whether the tournament trigger condition has been met is made in independence of any standard game play outcomes achieved on the gaming machines.

In an embodiment the determination as to whether the tournament trigger condition has been met is made in dependence of standard game play outcomes achieved on the gaming machines.

In an embodiment the minor prize is an award of credits having a fixed predefined value.

In an embodiment the minor prize is an award of credits having a value proportionate to one of the major prize value and the current prize pool value.

In an embodiment the tournament participation criteria is that a player has achieved at least one of the following within a predefined time period prior to commencement of the enrolment period: completed at least a set number of plays of the primary game; wagered at least a set number of credits on the gaming machine; and accumulated at least a set value of funds won through play of the primary game.

In an embodiment players of gaming machines that have not met the tournament participation criteria are able to enter the tournament through placing a separate tournament wager.

In an embodiment the tournament play period commences after either a set period of time has elapsed post commencement of the entry period, or after all players of the respective gaming machines have either opted in or out of the tournament.

In an embodiment the method further comprises notifying players of the gaming machines that the tournament play period has commenced.

In an embodiment the award condition is that either a predefined fixed time period or randomly determined time period has elapsed since commencement of the tournament play period.

In an embodiment the award condition is that a predefined threshold of won funds has been accumulated by one of the gaming machines that has entered into the tournament.

In accordance with a second aspect there is provided a method for conducting tournament game play in a gaming network comprising a plurality of inter-linked gaming machines, the method comprising:
implementing win meters associated with each of the gaming machines which are operable to record values of wins from games played thereon;
determining whether a tournament trigger condition has been met during a tournament trigger period during which players of the gaming machines are able to play respective primary games thereon;
entering gaming machines that meet a tournament participation criterion into a tournament; and
commencing a tournament play period during which time win meters associated with the gaming machines that have entered the tournament are evaluated for determining a winner of a tournament prize.

In an embodiment during the tournament play period players continue to play the respective primary games and wherein the tournament prize is awarded to the player who has accumulated the greatest win value at the end of the period.

In an embodiment gaming machines that meet the tournament participation criterion are entered into a dedicated tournament game which is played to determine the winner of the tournament prize.

In accordance with a third aspect there is provided a method for conducting a tournament game in a gaming network comprising a plurality of inter-linked gaming machines, the method comprising:
implementing a machine interface for each inter-linked gaming machine, the machine interface operable to communicate with a processor of the respective gaming machine to record data related to play of a primary game on the gaming machine;
determining whether a tournament trigger condition has been met during a tournament trigger period during which players of the gaming machines are able to play respective primary games thereon;
entering one or more of the gaming machines that meet a tournament participation criterion into the tournament; and
evaluating the recorded data for each gaming machine to determine a winner of a tournament prize.

In an embodiment the method further comprises requiring each player entering the tournament to register identification details and whereby a ranking of each player during the tournament play period is displayed in association with their identification details.

In accordance with a fourth aspect there is provided a tournament controller for a gaming system in which a plurality of inter-linked gaming machines are operating, the tournament controller comprising:
a tournament control module which is operable, under the control of a processor, to:
   (a) determine whether a tournament trigger condition has been met during a non-tournament play period during which players of the gaming machines are able to play respective primary games thereon;
   (b) responsive to determining that the tournament trigger condition has been met, commence a tournament entry period during which players of the gaming machines that meet a tournament participation criterion are offered the opportunity to enter a tournament in which a major tournament prize is awardable;
   (c) upon the tournament entry period closing, commence a tournament play period during which players of each of the inter-linked gaming machines are able to continue play of the respective primary games; and
   (d) responsive to determining that an award condition has been met during the tournament play period, award the major tournament prize to the player of a gaming machine that has entered into the tournament based on an evaluation of data related to play of the primary games on the respective gaming machines during the tournament play period.

In accordance with a fifth aspect there is provided a tournament controller for a gaming system comprising a plurality of inter-linked gaming machines, the controller comprising:
a processor operable to:
   implement win meters associated with each of the gaming machines, the meters being implementable to record values of wins from games played on the corresponding gaming machines;
   determine whether a tournament trigger condition has been met during a tournament trigger period during which players of the gaming machines are able to play respective primary games thereon
   allow players of gaming machines that meet a tournament participation criterion entry into a tournament; and
   commence a tournament play period during which time the win meters associated with the gaming machines that have entered the tournament are evaluated for determining a winner of a tournament prize.

In accordance with a further aspect there is provided a computer readable medium providing a computer program comprising at least one instruction which, when executed by a computer, is operable to implement the method in accordance with any of the first through third aspects as described above.

### BRIEF DESCRIPTION OF THE DRAWINGS

Preferred embodiments of the invention will now be described, by way of example only, with reference to the accompanying drawings, in which:

FIG. 1 is a schematic view of a gaming device in accordance with an embodiment;

FIG. 2 is a schematic of a gaming system including a plurality of inter-linked gaming devices according to an embodiment; and

FIG. 3 is a flowchart illustrating a method of operating a gaming device, in accordance with an embodiment.

### DETAILED DESCRIPTION

Embodiments relate to systems and methods for providing tournament play to players of inter-linked gaming devices operating in a gaming network. Embodiments advantageously allow for tournament play to be provided on gaming devices that have not been specifically configured to implement such play. Particular embodiments also allow for tournament play to be based on play of primary games (also commonly referred to as “main games” which may or may not offer feature events as will be understood by persons skilled in the art) for each of the inter-linked gaming machines, thereby avoiding the need to design and run a dedicated tournament game.

### General Gaming Device Construction

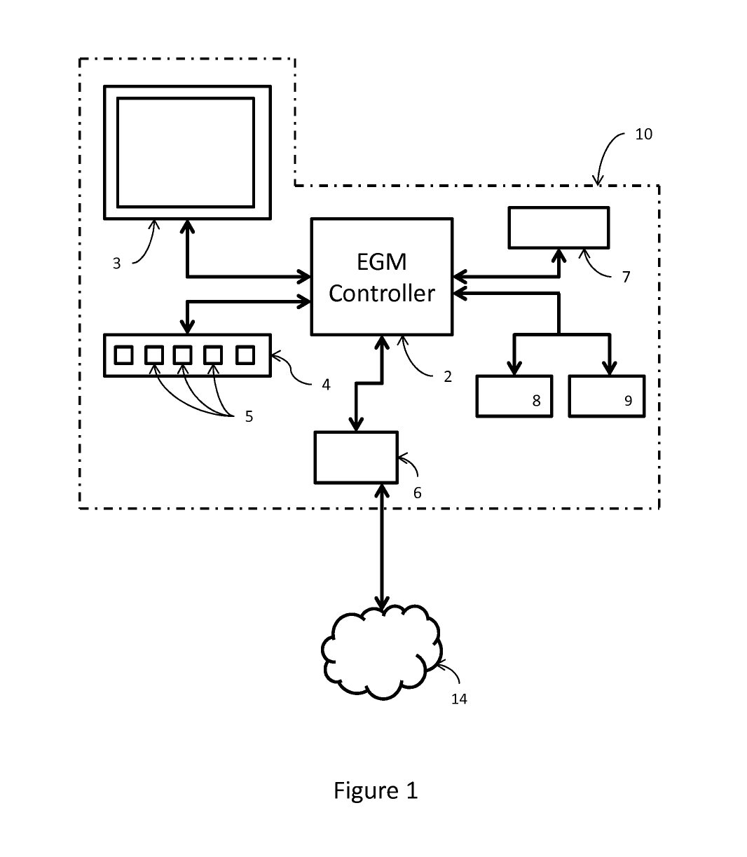

Referring to FIG. 1 there is shown an exemplary gaming device 10 for use with a gaming network of the type typically used in casinos. The gaming device 10 is in the form of an electronic gaming machine (EGM) which includes various standard components, such as a game controller 2 implementing game logic for controlling the operation of the device and the primary game which it runs. The device 10 comprises one or more displays 3, such as plasma screen displays, for displaying game screens. A player input means 4 is provided for enabling a user to interact with the device 10 and may include, for example, a bank of buttons 5 located in a mid-trim of the device 10. The buttons 5 may alternatively or additionally be provided as part of the display 3, in a touch-screen type manner.

The device 10 also implements a note acceptor 7 (also commonly referred to as a bill acceptor or validator) adapted to accept bank notes as well as cashless instruments, such as paper tickets or coupons, for inputting credits. The note acceptor 7 is additionally configured to accept and dispense notes and tickets/coupons, for paying out winnings. A coin input chute 8 and output tray 9 are provided as an alternative means for inputting credits and dispensing cash winnings, respectively. The device 10 further incorporates a network interface comprising various input and output ports for network communications, as will be well understood by persons skilled in the art.

The device 10 may also comprise a reading device (e.g. a card scanner for reading a loyalty card or other form of portable storage medium capable of being read by the card scanner) which communicates with a player tracking module for providing player tracking and loyalty type functions. According to the presently described embodiment, the player tracking module is implemented by a central controller (as will be described in more detail in subsequent paragraphs). It will be understood, however, that the player tracking module may be implemented by other network connected elements. For example, the player tracking module may be implemented by a dedicated external player tracking system which is communicable with the gaming device by way of the network interface.

### Machine Interface Card

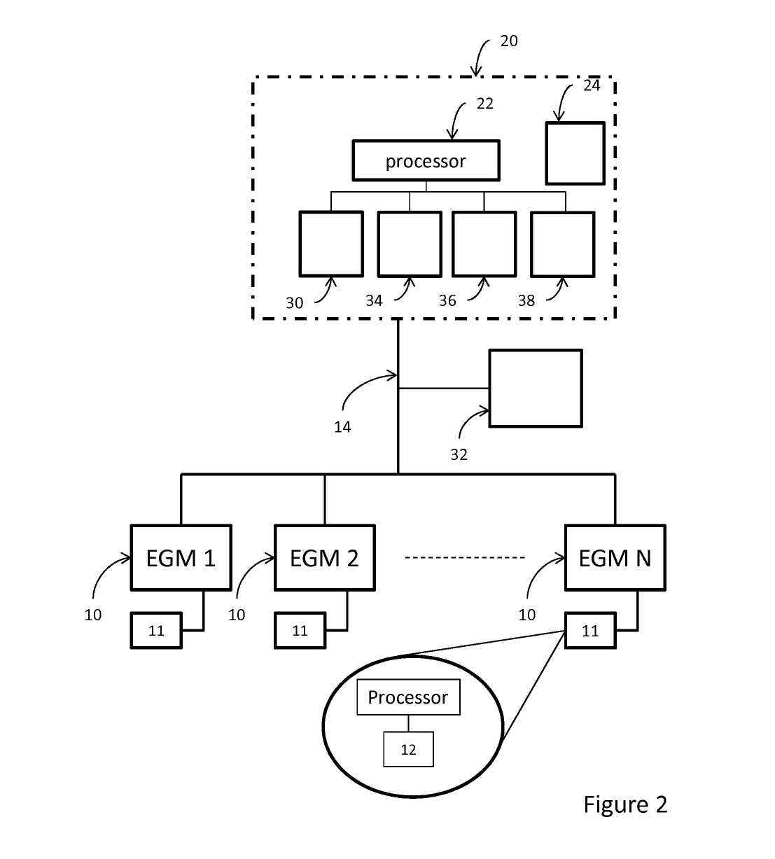

With additional reference to FIG. 2, a plurality of the FIG. 1 gaming devices 10 are shown in communication with a central controller 20 over a network 14 for the provision of tournament play. According to the illustrated embodiment, the gaming network 14 comprises a local area network (LAN), although it will be understood that embodiments are not so limited (e.g. the gaming devices could be communicable over a WAN, or any suitable secure network arrangement).

To allow the gaming devices 10 to communicate with the central controller 20 (and thereby participate in the tournament), they are each provided with a machine interface card 11 (as shown in detail for the first gaming device 10a). The interface card 11 connects to the respective gaming device by way of a suitable interface port on the network interface and includes the appropriate network componentry for communicating with the central controller 20 (e.g. using SAS protocol). More particularly, the machine interface card 11 comprises a processor which is operable to implement a tournament game module 12 which is communicable with the corresponding game device 10 for receiving data related to play of the primary game. According to the illustrated embodiment, such data includes data indicative of coin in values, number of games played and prize values won through play of the primary game, which data is subsequently communicated to the central controller 20 for use in determining a tournament winner (as will be described in more detail in subsequent paragraphs). It will be understood that the data related to play of the primary game may include any gaming data that is determined by the gaming device processor 2 and communicable to the network interface.

The tournament game module 12 is also operable to provide other tournament related functions, including displaying tournament related information on the gaming device display (or some other display viewable by a player), receiving player instructions related to tournament play and updating in-machine credit meters based on tournament prizes. According to the illustrated embodiment, the tournament game module 12 is capable of interrupting a gaming device display signal to display the tournament related information (e.g. overlaying, or resizing and utilising the additional real estate of the primary game screen).

It will be understood that the machine interface card 11 may be implemented as any suitable combination of programmed logic circuitry, including, for example, hardware, software or a combination thereof.

### Detail of the Central Controller

According to the presently described embodiment, the central controller 20 takes the form of a server computer (hereafter central server) which implements three main modules (described below), under the control of a processor 22 and based on program code stored in memory 24. The central server communicates with the gaming devices 10, via the machine interface card 11. The central server 20 includes a display controller 30 for causing a display screen 32 to display information relating to tournament game play, including tournament prize values, player rankings and tournament prize winners.

A management and accounting module 34 provides management and accounting functions, also sometimes called auditing functions. Typically, these functions gather and/or report coin-in and coin-out operations, door openings (e.g., when a gaming device is serviced), service cycles in general, ticket replacements, and the like. This activity generally is linked to the game being played on the gaming device and/or the gaming device itself.

A player tracking module 36 provides player tracking functions. More specifically, such systems link players of gaming devices to particular activities undertaken by the players. The information typically tracked for each player includes, for example, the session of game play (e.g., date, time, location, type of machine, type of game, etc.) as well as the individual's profile (e.g., name, address, and/or other identifying information). In an alternative embodiment, the central controller 20 may only record minimum player tracking information required to implement tournament play (e.g. unique information entered by a player to record tokens and display player rankings, as will be discussed in more detail below). In yet another alternative embodiment, the central controller 20 may communicate with an external player tracking system to obtain the relevant player tracking information for permitting tournament play.

A tournament control module 38 is operable to administer tournament play. According to the illustrated embodiment, tournament play involves evaluating funds won through primary game play on the gaming machines during a tournament play period and awarding a prize to the player who has accumulated the greatest value of won funds, upon determining that an award condition has been met. In alternative embodiments, the tournament control module 38 may evaluate other data related to primary game play (i.e. communicated by the respective machine interfaces 11) to determine the tournament winner. For example, the control module 38 may evaluate total coin in with the tournament prize awarded to the player that has recorded the greatest total coin in value for the tournament play period. As another example, the control module 38 may evaluate both total coin in and won funds values and award the prize to the player who has achieved the smallest total net loss (i.e. coin in less won funds) for the tournament play period. In yet a further example, the control module 38 may evaluate the number of games played by each player during the tournament play period with the prize awarded to the player who has played the most games. In particular embodiment, the control module 38 may evaluate primary game play outcomes during the tournament play period for determining player rankings in the tournament. For example, the control module 38 may evaluate the number of successful double ups within the primary game with the prize awarded to the player who has achieved the greatest number of successful double ups during the tournament play period. It will be appreciated that these are but a number of examples illustrating types of data communicable from the machine interface 11 that could be evaluated for determining tournament player rankings. Tournament play can thus be achieved without needing the game controllers 2 of the networked gaming devices 10 to be specially configured to implement a tournament game, thereby allowing any standard gaming device 10 which implements a machine interface card 11 (as previously described) to participate in tournament play. Another advantage arising through such an implementation is that the tournament prize may be self-funding (i.e. players effectively use their own money to race for the tournament prize).

In order to achieve the above described functionality, the tournament control module 38 is operable to communicate with the respective machine interface cards 11 for receiving the data related to play of the primary game (which for the purposes of illustration will hereafter be described based on the won funds data example outlined above). A ranking table is stored in memory 24 which records for each participating gaming device 10 a current accumulated value of funds won during a tournament play period (based on the won funds data received from each of the machine interface cards 11 throughout the tournament play period). At the end of the tournament play period the ranking table is reset, ready for commencement of the next tournament.

The tournament control module 38 is also operable to administer a tournament prize pool which funds a progressive jackpot prize awardable to a winner of the tournament. In this regard, it will be understood that gaming activity on the gaming devices 10 results in a progressive prize pool value being incremented. According to the presently described embodiment, a percentage of each wager placed by players of the gaming devices 10 on the respective primary games is allocated to the progressive prize pool.

Finally, the necessary conditions and criterion for determining when to trigger tournament play, when to award a tournament prize and the like are stored in memory 24 in a rule store.

### Tournament Play

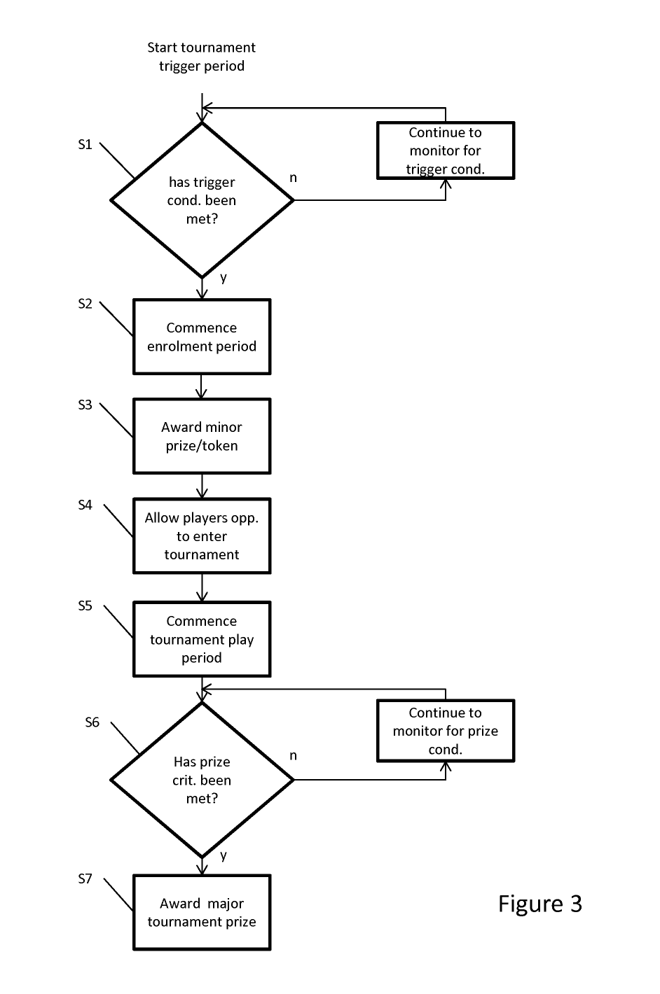

According to the illustrated embodiment, tournament play consists of three distinct periods, namely a tournament trigger period; enrolment period and tournament play period. Each of the three periods will now be described with reference to the flow diagram of FIG. 3.

In a first step S1, the tournament control module 38 evaluates relevant trigger condition parameters to determine whether a tournament trigger condition has been met during a tournament trigger period. During this period players of each of the gaming devices 10 are able to play primary games (which may or may not be the same primary game for each gaming device) in the usual manner, with a portion of turnover from each wager allocated to the prize pool. In a particular embodiment, the tournament trigger condition is that a value of the progressive jackpot prize has reached a predefined amount, a randomly determined amount (i.e. within some predefined range set by the tournament control module 38), or that some randomly determined or fixed time period has expired. The current jackpot prize value as well as the predefined or randomly determined amount/range/time may or may not be displayed to players (e.g. on the display screen 32), depending on the desired implementation. It will be understood that other tournament trigger conditions may equally be implemented depending only on the desired implementation. For example, the tournament trigger condition may be that some predefined symbol combination or game play outcome has been achieved on one of the gaming devices 10 (i.e. as determined from the data output by the machine interface 11).

At step S2, responsive to determining that the tournament trigger condition has been met, the tournament control module 38 commences an enrolment period. At step S3, players of gaming devices that have met a tournament participation criterion are awarded a minor tournament prize, which they must forfeit/exchange in order to enter the tournament (step S4). According to the presently described embodiment, the tournament participation criteria is that at least one wager has been placed on the primary game within some predefined time period (e.g. 30 seconds) prior to commencement of the enrolment period. It will be understood that other tournament participation criteria are equally applicable, including, for example, criteria that take into consideration, wager amounts, won funds, number of plays, etc. within the predefined period leading up to commencement of the enrolment period.

The minor tournament prize make take the form of any one or more of the following:
machine credits paid to the credit meter of the respective gaming devices 10
a cash prize which may be made from a local cash hopper, funds permitting, or by payment to an account or a smartcard, by issuing of a voucher which may be redeemable at a cashier, etc.
a token which can be used by the player to either entering into the current tournament or saved for entry into a future tournament where their gaming device has not met the participation criterion. The token may be stored against their player profile by the player tracking module using the details entered during the player registration information entered by the player at the EGM, or a player accounting system provided by a third party.

Where the minor prize takes the form of cash or credits, the prize may be funded from the prize pool. Depending on the desired implementation, the value may be a set fixed value or a value which is proportionate to the size of the pool. In an alternative embodiment, the prize may be funded by the gaming venue. The minor prize value may be displayed to the players, for example on their gaming device display or the tournament display screen 32.

Still with reference to step S4, the tournament control module 38 may instruct the tournament game module 12 to display a tournament entry interface screen on the respective game device for allowing the player to make their selection as to whether or not they wish to partake in tournament play (i.e. to forfeit/exchange the award or tokens for entry into the tournament, or retain the award and forgo play in the current tournament). The interface may interrupt the normal game play screen so that play is interrupted until the player has made their selection, or alternatively be displayed together with the normal game play screen allowing players to continue placing wagers on the primary game while the interface is displayed. In a particular embodiment, players who wish to enter the tournament may also be asked to enter player identification registration details which are recorded in the player ranking table. After a predefined period of time, the tournament control module closes the enrolment period. It will be understood that the jackpot prize may continue to increase in value during the enrolment period based on wagers placed on the primary games during this period.

In a particular embodiment, where a player has not qualified for entry into the current tournament they may be allowed to place a dedicated tournament wager of some predefined value in order to qualify for entry, or use a previously retained token. The tournament wager value may be a fixed value, a value which is proportionate the jackpot prize value, or some other suitable value determined by the gaming venue.

At step S5, a tournament play period commences and a suitable notification is displayed to players who have entered the tournament, e.g. by way of the gaming device display or central display screen 32. Thereafter, players continue to play their gaming machines in the normal manner (i.e. such that they continue to wager credits for primary game play with winning credits being added to their credit meter, but which credits are also communicated to the controller for determining player rankings). The player rankings are continuously displayed on the central display screen 32 during tournament play period (a personalised player ranking may also be displayed on the individual gaming device displays, e.g. “you are currently 28^{th} out of 45 players”). As for the enrolment period, the major tournament prize may increase in value during the tournament period through primary game play on the gaming devices 10.

In response to an award condition being met during the tournament play period (as determined in step S6), the tournament control module 38 evaluates the accumulated won funds for each player (or whatever relevant primary game data is being used to determine player rankings), for determining a tournament winner. It will be understood that the jackpot award condition may vary depending on the desired implementation, but may include, for example, any one of the following conditions:
a predefined time period has elapsed;
a randomly determined time period within a set range has elapsed;
the jackpot prize has reached a predefined value;
the jackpot prize has reached a randomly determined value between a set range;

According to the embodiment described herein, the major tournament prize is in the form of a jackpot prize which is awarded when an accrued turnover amount for the prize pool reaches a predetermined threshold. Such a system is disclosed in co-pending PCT application no. PCT/AU2004/001444, which is incorporated herein by reference. In this kind of system, the tournament control module 38 stores in memory 24 data indicative of a predefined jackpot value and of an accrued prize value. The jackpot trigger condition is met when the accrued prize value reaches the predetermined jackpot value.

In step S6, according to the illustrated embodiment, the jackpot prize is awarded to the player who has accumulated the greatest value of won funds (i.e. credits) since the tournament play period commenced. After the major tournament prize has been awarded (step S7), the ranking table is subsequently reset before play returns to step S1. The major tournament prize may be awarded using any of the techniques as previously described for the minor tournament prize.

In an alternative embodiment to that described above, upon commencement of the tournament play period, the tournament game modules (under instruction from the tournament control module) may cause the displays of the respective gaming devices to display a dedicated tournament game to the players. For example, the tournament game may comprise a simulated table game, such as baccarat with the minor prize being used to fund player wagers. Play of the dedicated tournament game may be controlled by the tournament control module 38 or by the individual tournament game modules 12. It will be understood that for such an embodiment, the tournament game modules 12 would need to interact with the respective game controllers 2 to receive player inputs for play of the dedicated tournament game or receive player instructions from some other input means (e.g. the machine interface cards 11 may provide their own player inputs). In this regard, the dedicated tournament game could be displayed overlaying the primary game screen, or the primary game screen could be resized to allow the player to view the selections in the additional screen real estate provided by the resizing of the primary game screen. In yet another alternative embodiment, a separate game display could be provided for displaying the tournament game.

It will be understood that the major tournament prize may take forms other than a progressive jackpot prize. For example, the major tournament prize may include any form of monetary prize or award of credits the value of which may or may not be related to a size of the prize pool. In a particular embodiment, the major tournament prize is randomly selectable from a group of prizes having different prize types and/or values. In a particular embodiment the major tournament prize may be a non-monetary prize, such as loyalty points, reward points, coupons, etc.

Embodiments could provide tournament play for separate or multiple banks of gaming machines in a venue, with the possibility of having bank or area winners as well as major winners. The tournament could be implemented across multiple gaming venues (e.g. across as WAN). Again this may involve providing bank, area and venue prize winners.

In an alternative embodiment to that described above, the tournament play period for each player may end at a different time. For example, the tournament play period may last for some predefined number of spins/plays of a game (e.g. the tournament play period may end after 100 spins), such that some players may complete the required number of spins before other players. In this case, the ranking displayed to players may include current player spin number, score, and position in tournament (e.g. 54^{th}/528). An advantage of having the tournament play period being spin/play based is that it more closely replicates a race, in turn increasing player excitement.

Some embodiments of the invention are provided in a single gaming establishment in which the user-operable terminals are gaming machines at the establishment. In alternative embodiments, the gaming devices are distributed among a number of such establishments or other locations and/or include other devices such as personal computers. In such latter cases, communication between the devices and the central controller is effected for example by means of an existing network, such as the internet, or by telephone dial-up or radio communication or by a combination of the above.

In further embodiments, systems according to the invention are provided in, or in combination with, the systems disclosed in co-pending Australian patent application numbers 2005901326, 2004906409, PCT patent applications numbers: PCT/AU2004/001444, PCT/AU2005/000670, PCT/AU2005/000668, PCT/AU2005/001473, PCT/AU2005/000659, PCT/AU2005/000669, PCT/AU2005/000615, and PCT publication numbers WO 2005/008514 A1, WO 2005/083599 A1, the full contents of each of which is herein incorporated by reference. Furthermore, the functionality of various components, such as the central controller, have been described as being performed by distinct devices, such as dedicated integrated circuits. However, in preferred embodiments, all or any combination of their functionality is instead performed by multi-purpose integrated circuits or implemented in software executed on a microprocessor. Particularly in such cases, the invention is additionally embodied in a computer program or in a computer program in a data signal or stored on a data carrier.

1. A method for conducting tournament game play in a gaming network comprising a plurality of inter-linked gaming machines, the method comprising:
determining whether a tournament trigger condition has been met during a non-tournament play period during which players of the gaming machines are able to play respective primary games thereon;
responsive to determining that the tournament trigger condition has been met, commencing a tournament entry period during which players of the gaming machines that meet a tournament participation criterion are offered the opportunity to enter a tournament in which a major tournament prize is awardable;
upon the tournament entry period closing, commencing a tournament play period during which players of each of the inter-linked gaming machines are able to continue play of the respective primary games; and
responsive to determining that an award condition has been met during the tournament play period, awarding the major tournament prize to the player of a gaming machine that has entered into the tournament based on an evaluation of data related to play of the primary games on the respective gaming machines during the tournament play period.

2. A method in accordance with claim 1, wherein the data related to play of the primary games comprises data indicative of funds won through play of the primary games and wherein the major tournament prize is awarded to the gaming machine which has accumulated the greatest value of funds won during the tournament play period.

3. A method in accordance with claim 2, further comprising evaluating a win meter for each of the gaming machines which records a number of credits won through play of the respective primary game to determine which of the gaming machines has accumulated the greatest value of won funds.

4. A method in accordance with claim 2, further comprising displaying a ranking during the tournament play period for each of the gaming machines that have entered into the tournament based on the current value of won funds as determined from the respective win meters.

5. A method in accordance with claim 1, further comprising awarding a token to players of inter-linked gaming machines that meet the tournament participation criterion, the token being used to enter into the current tournament or stored against a player profile for use in entering into a future tournament where the player has not met the tournament participation criterion.

6. A method in accordance with claim 1, further comprising awarding a minor prize to all players of inter-linked gaming machines that meet the tournament participation criterion.

7. A method in accordance with claim 6, further comprising requiring players to forgo the minor prize in order to enter into the tournament.

8. A method in accordance with claim 1, wherein each of the inter-linked gaming machines contribute a portion of turnover from play of the respective primary games to a prize pool from which the tournament prize(s) are funded.

9. A method in accordance with claim 8, wherein the major tournament prize is a progressive jackpot such that a value of the jackpot prize is proportionate to a value of the prize pool.

10. A method in accordance with claim 9, further comprising allowing the jackpot prize value to increase during the tournament entry period through play of standard games on any one of the inter-linked gaming machines.

11. A method in accordance with claim 9, further comprising displaying a current jackpot prize value to players during the enrolment period.

12. A method in accordance with claim 8, wherein the tournament trigger condition takes into consideration a current value of the prize pool and/or jackpot prize.

13. A method in accordance with claim 8, wherein the determination as to whether the tournament trigger condition has been met is made in independence of any standard game play outcomes achieved on the gaming machines.

14. A method in accordance with claim 8, wherein the determination as to whether the tournament trigger condition has been met is made in dependence of standard game play outcomes achieved on the gaming machines.

15. A method in accordance with claim 6, wherein the minor prize is an award of credits having a fixed predefined value.

16. A method in accordance with claim 6, wherein the minor prize is an award of credits having a value proportionate to one of the major prize value and the current prize pool value.

17. A method in accordance with claim 1, wherein the tournament participation criteria is that a player has achieved at least one of the following within a predefined time period prior to commencement of the enrolment period: completed at least a set number of plays of the primary game; wagered at least a set number of credits on the gaming machine; and accumulated at least a set value of funds won through play of the primary game.

18. A method in accordance with claim 1, wherein players of gaming machines that have not met the tournament participation criteria are able to enter the tournament through placing a separate tournament wager.

19. A method in accordance with claim 1, wherein the tournament play period commences after either a set period of time has elapsed post commencement of the entry period, or after all players of the respective gaming machines have either opted in or out of the tournament.

20. A method in accordance with claim 1, further comprising notifying players of the gaming machines that the tournament play period has commenced.

21. A method in accordance with claim 1, wherein the award condition is that either a predefined fixed time period or randomly determined time period has elapsed since commencement of the tournament play period.

22. A method in accordance with claim 2, wherein the award condition is that a predefined threshold of won funds has been accumulated by one of the gaming machines that has entered into the tournament.

23. A method for conducting tournament game play in a gaming network comprising a plurality of inter-linked gaming machines, the method comprising:
implementing win meters associated with each of the gaming machines which are operable to record values of wins from games played thereon;
determining whether a tournament trigger condition has been met during a tournament trigger period during which players of the gaming machines are able to play respective primary games thereon;
entering gaming machines that meet a tournament participation criterion into a tournament; and
commencing a tournament play period during which time win meters associated with the gaming machines that have entered the tournament are evaluated for determining a winner of a tournament prize.

24. A method of conducting a tournament in accordance with claim 23, wherein during the tournament play period players continue to play the respective primary games and wherein the tournament prize is awarded to the player who has accumulated the greatest win value at the end of the period.

25. A method in accordance with claim 23, wherein gaming machines that meet the tournament participation criterion are entered into a dedicated tournament game which is played to determine the winner of the tournament prize.

26. A method for conducting tournament game play in a gaming network comprising a plurality of inter-linked gaming machines, the method comprising:
implementing a machine interface for each inter-linked gaming machine, the machine interface operable to communicate with a processor of the respective gaming machine to record data related to play of a primary game on the gaming machine;
determining whether a tournament trigger condition has been met during a tournament trigger period during which players of the gaming machines are able to play respective primary games thereon;
entering one or more of the gaming machines that meet a tournament participation criterion into the tournament; and
evaluating the recorded data for each gaming machine to determine a winner of a tournament prize.

27. A method in accordance with claim 1, further requiring each player entering the tournament to register identification details and whereby a ranking of each player during the tournament play period is displayed in association with their identification details.

28. A tournament controller for a gaming system in which a plurality of inter-linked gaming machines are operating, the tournament controller comprising:
a tournament control module which is operable, under the control of a processor, to:
(a) determine whether a tournament trigger condition has been met during a non-tournament play period during which players of the gaming machines are able to play respective primary games thereon;
(b) responsive to determining that the tournament trigger condition has been met, commence a tournament entry period during which players of the gaming machines that meet a tournament participation criterion are offered the opportunity to enter a tournament in which a major tournament prize is awardable;
(c) upon the tournament entry period closing, commence a tournament play period during which players of each of the inter-linked gaming machines are able to continue play of the respective primary games; and
(d) responsive to determining that an award condition has been met during the tournament play period, award the major tournament prize to the player of a gaming machine that has entered into the tournament based on an evaluation of data related to play of the primary games on the respective gaming machines during the tournament play period.

29. A tournament controller for a gaming system comprising a plurality of inter-linked gaming machines, the controller comprising:
a processor operable to:
implement win meters associated with each of the gaming machines, the meters being implementable to record values of wins from games played on the corresponding gaming machines;
determine whether a tournament trigger condition has been met during a tournament trigger period during which players of the gaming machines are able to play respective primary games thereon;
allow players of gaming machines that meet a tournament participation criterion entry into a tournament; and
commence a tournament play period during which time the win meters associated with the gaming machines that have entered the tournament are evaluated for determining a winner of a tournament prize.
